(19) United States
(12) Patent Application Publication
(10) Pub. No.: US 2006/0070126 A1
(43) Pub. Date: Mar. 30, 2006

(54) A system and methods for blocking submission of online forms.

(76) Inventor: Amiram Grynberg, Neve Efrayim Monson (IL)

Correspondence Address: AMIRAM GRYNBERG, 24 RIMON ST, NEVE EFRAYIM MONSON, 60190, IL

(21) Appl. No.: 10/711,579

(22) Filed: Sep. 26, 2004

(51) Int. Cl. G06F 12/14

(52) U.S. Cl. 726/22

(57) ABSTRACT

A system and methods for blocking submission of online forms to suspicious web sites comprising detection of sensitive form fields before a form is submitted, analysis of URL and certificate target sites against security criteria to generate an alert codes and matching alert code with blocking criteria to generate a block submission message.

### BACKGROUND OF THE INVENTION

The Internet in general and specifically the World Wide Web help people and organizations connect with each other for business and pleasure. However, the Internet also proves to be a new play media for scamming and fraud.

As more people (users) enter personal and private data into Web forms through web browsers, other parties (attackers) have looked for ways to defraud users and retrieve said personal data using various methods.

In particular, a method called “Phishing” has become popular recently. Using that method, an attacker prepares a bogus web site that resembles a real existing site (cloned site). The attacker then sends an email to a user prompting said user to visit the spoofed web site for important business related to the cloned site. Many times the cloned sites are financial institutions or other organizations where users have accounts with.

A user visiting the spoofed site is asked to enter secret credentials into an online form as part of the ‘identification process’. Since the spoofed site seems similar to a real site the user may be doing business with, users fall into such a trap and provide secret information like passwords, credit card numbers and other related information.

Financial institutions and others are actively looking for solution to this problem. (see http://www.antiphishing.org for case studies and working committees, which is incorporated here by reference). In a report issued by Anti Phishing Working Group on May 24, 2004 they say: “Reports of Email Fraud and Phishing Attacks Increase By 180% in April; Up 4.000% Since November”

Several solutions have been proposed to date. In one solution, called “SpoofStick” a software program monitors sites the user is accessing and displays to the user the site's domain name in the browser's title. In another solution called “Web Caller-ID”, a software extension to a browser, performs an analysis of a web site the user is accessing trying to figure out if it's a real one or a fake. The program analyses the structure of the site and its links to try and reach such a determination. However, the most popular approach is offered by companies like Symantec Inc. who use anti virus techniques to filter out emails carrying the original links to the spoofed sites. They use white lists and web analysis techniques.

While the aforementioned techniques help mitigate the problem, they are not fool proof and they delay a user's interaction with a Web site because of the need to check out the structure of the target site during each access.

It is therefore, highly desirable to have a software solution that each user could adopt, whereby the software would be invisible to the user during normal surfing on the net and that software would intervene when a user is about to submit sensitive personal data to a suspicious web site.

### SUMMARY OF THE INVENTION

The current invention describes a system and methods for warning users of suspicious web sites just before submitting sensitive data to such sites.

A monitoring software module executing on a computer, monitors a user's access to web sites. Said software hooks itself to a web browser software module or to the operating system so as to receive notifications when said user receives information from a web site, or when said user is about to send information to a web site.

The monitoring software parses and reads an HTML page a user is presented with, it then reads the information a user enters to the form and associates entered data with its intended use. When said monitoring software detects sensitive data like passwords, credit card numbers, social security numbers etc., it waits for a notification of submittal of said form.

Once a notification is received about a pending submittal, the monitoring software, examines the URL to which it is being sent. In a preferred embodiment of this invention, an alert is generated if the protocol used to send the information to the Internet is not secure (does not use SSL) or the secured server uses a non valid server certificate.

Once an alert is generated, a user is presented with additional information about the suspicious site, like the name of its owner, its creation dates etc. letting said user to decide whether to continue with submission or cancel it.

### BRIEF DESCRIPTIONS OF THE DRAWINGS

FIG. 1 is a generic system block diagram.

FIG. 2 is a diagram of HTML forms alert system

FIG. 3 id a flowchart of a certificate processing module

FIG. 4 is a diagram of non-HTML forms alert system

### DETAILS OF THE INVENTION

Users browse the Internet using various tools like PCs, hand held computers, TV sets, cell phones and special purpose gadgets. Through those instruments they can access various web sites. Many web sites require users to sign-in with a password before they can transact business with those sites. So, users are accustomed to having to provide sign-in credentials to web sites.

When users receive an email directing them to a web site to transact some business, they naturally assume that if they recognize the name of the company which refers them to the site and if they find the site similar in look and feel to what they expect from that company, that the site is indeed the real site of that company.

Malicious users (attackers) who wish to fraudulently extract from regular users secret and personal information, leverage the natural trust people assign to Web sites of companies they know. They, the attackers, mimic the original site of a company (cloned site) and clone it to create a “spoofed” site. The spoofed site looks very professional and is very hard to discern from the original site. Attackers, lure naïve users to the spoofed site using threats or promises. Either way, users end up signing in to the spoofed web site providing almost any information an attacker requests from them. This tactic by attackers is also known as “Phishing”.

When a user is lured (usually through an email) to a web site, that web site must have an address associated with it. An address (URL) would usually have one of the following forms:
(1)http://<ip address>/<page>
(2)http://<server>.<domain>/<page>
(3)https://<server>.<domain>/<page>
   Where <server>represents a server name (like “myhost”), <domain>represents a domain name (like “mydomain.com”) and a <page>represents additional parameters that define a particular page.
   <ip address> represents an Internet address in the form of xxx.xxx.xxx.xxx where x represents a digit. While there are additional forms to address Internet information, the above represent the most common ones.

Analysis of the so called “phishing” attempts shows that most use the first form and the rest use the second form. The third form is rarely used. The reason is simple. Every computer or device connected to the Internet has an IP address associated with it. Most computers use a temporary address assigned to them each time they connect with their service provider. Thus, it is hard to trace those computers based on their IP address as it changes each time they turn them on.

However, since an IP address type is quite suspicious to even the non experienced user, attackers prefer to user the second form of address. For the second form, an attacker needs to set up a domain name with an established registrar. Theoretically, when a web site is registered, the owner's name and address are disclosed, thus making it easier to pursue and prosecute such Attackers. However, there is no checking of credentials during a domain registration, allowing attackers to provide false identity and avoid detection.

The third form of address which uses the “https” prefix, is one that provides high level of security for users connecting with sites. With this form (also known as the https protocol or SSL), any data sent by a user to the site's server is encrypted. Because of security issues, many companies provide a secured sign-in and payment pages on their Web sites using the https protocol.

To be able to provide an https protocol service, a site's owner must register with an authentication authority and prove to their satisfaction, the identity of the site's owner. Once approved, a site receives a digital “certificate” that proves its authenticity. When a client device connects to a site's server using the https protocol, the client device is presented with the digital certificate of the server. Such a certificate is authenticated by the client's software, usually a web browser. The above procedure is well known to anyone skilled in the art of software security and communication.

The current invention describes a system and methods for warning users of fraudulent attempts to extract information from them using a spoofed web site. The system comprises a monitoring software module that is linked to a web surfing software and other software modules executing on a user's computer or device. The methods described below show a process for handling data in a computer's memory in a manner that produces a physical alert when a fraud attempt is suspected.

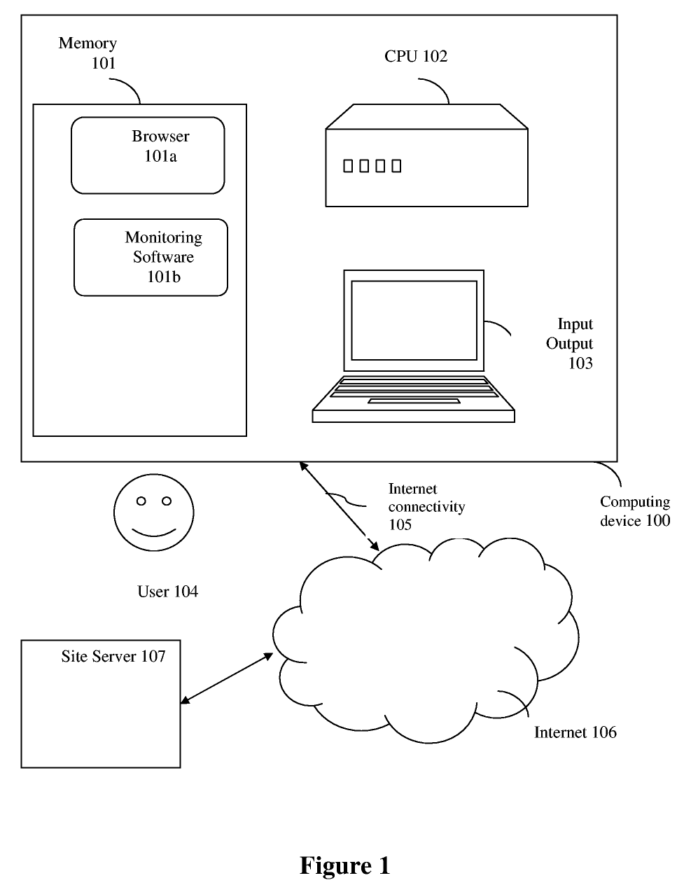

FIG. 1 is a generic block diagram of a preferred embodiment of the current invention on a computing device 100. It contains the main modules participating in the system. Memory unit 101 holds program modules and data required for the implementation of the invention. In particular a web browser software and a monitoring software. Memory unit 101 includes a non volatile and volatile storage. Central processing unit 102 executes the code required to implement the current invention. Input/Output unit 103 containing a keyboard, mouse and a monitor, facilitate physical interaction with user 104. Internet connectivity 105 provides the required connection to the Internet 106 which in turn in connected to a server 107 of a target site for the information to be submitted by user 104. It should be clear to anyone skilled in the art that the division of the system into separate modules in a manner described above is just one possible implementation. In fact, the monitoring software could be made an integral part of a browser software module. Furthermore, input/output means could be devised in many ways to achieve the same functional requirements.

The Web browser described in 101a is any browser that provides access mechanism to its internal data structures where it holds the content of a web page it loads. Furthermore, said browser should provide notifications to monitoring software 101b when a page is loaded or submitted to a Web site and allow said monitoring software to block such submission. An off the shelf product like Internet Explorer by Microsoft Inc. satisfies these requirements. However, any browser that provides for the required interfaces is suitable. It is be clear that a browser which incorporates monitoring software 101b as part of the browser does not need to provide external access and notifications as long as internally it does.

Web browser 101a is connected to the Internet 106 via an Internet connection 105. A user 104 navigates the browser to a web site via the input output means 103, by inputting a URL in its address bar, by clicking on links in the browser or by clicking on links in other computer programs that contain links. A web page is presented to a user via the display output means 103. User 104 in response to a page display on 103, enters via 103 data into form fields presented as part of a Web page. Monitoring software 101b checks the submitted form data fields and alerts the user via display 103, if one or more criteria are met.

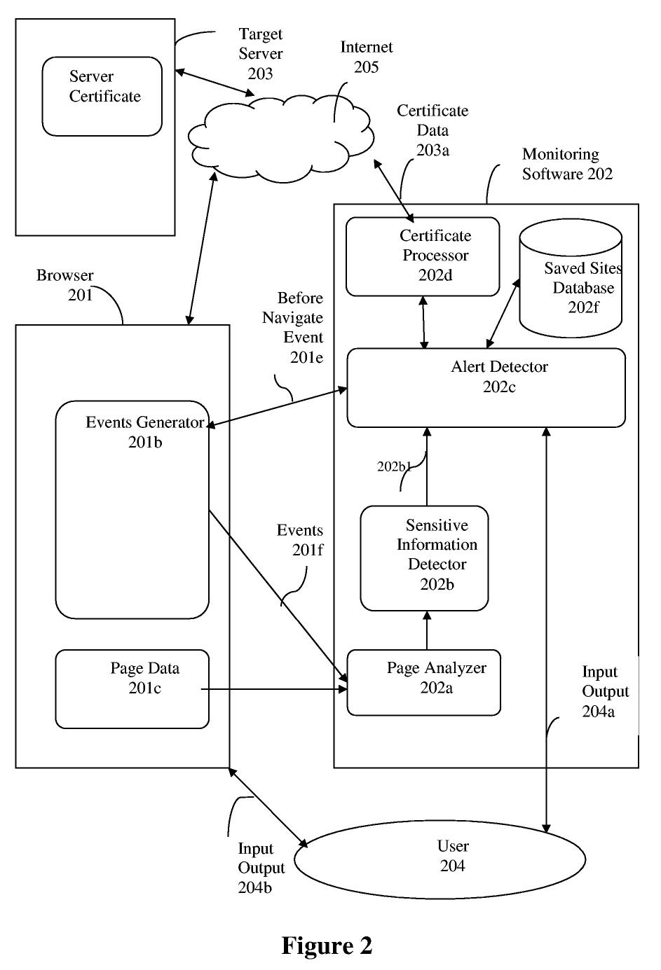

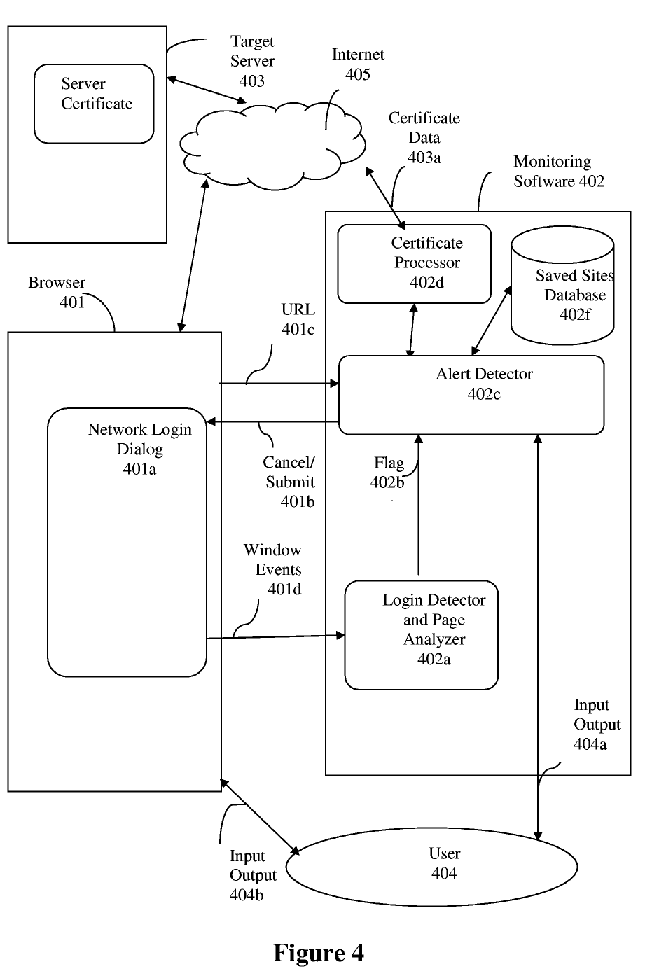

FIG. 2, provides a more detailed diagram of the monitoring software 101b (202), browser 101a (201) and the information flow though the various components of the system for the case of HTML forms. FIG. 4 provides details of a non HTML based forms.

In FIG. 2, as a web page is received by browser 201, it generates an event by events generator 201b. Said event is dispatched to page analyzer 202a. Internet Explorer generates a “document complete” event). Similarly when a page is about to be sent to a site server, events generator 201b generates an event signaling Page Analyzer 202a and Alert Detector 202c to that fact. Any of the above mentioned events, causes page analyzer 202a to reads page data 201c and parse it into fields of information.

Page Analyzer 202a parses Page Data 201c by reading the contents of the page and determining for each form field the contextual meaning of the field. Page Analyzer 202a can access Page Data 210c document object model (DOM) via an Application program Interface (API) exposed by Browser 201. An w3.org standard for DOM is supported by most browsers.

The methods of determining context meaning for form fields is not new. It is used by commercial available form filling programs like www.google.com. The purpose of form fillers is to associate a form field with preconfigured data to facilitate automatic form filling. A form filler, reads the “type” attribute of an input field, the name of the field and text surrounding the field in order to determine its meaning in the context of a web form. If a “type=password” attribute is detected for a field, its clear that this is a password field. If a “name=xxx” attribute is detected where xxx conforms to some standards for naming fields (see http://www.ietf.org/rfc/rfc3106.txt), the meaning again is clear. The most difficult part is recognizing fields from text surrounding such fields. Several methods are employed including dictionary lookup and structural analysis.

Although, it is possible for Page Analyzer 202a to determine that a certain field is a password field simply by finding a “type=password” attribute of that field, this may not be enough. Attackers may present to users fields which behave like password fields but are not marked as “type=password”. Such hacking is possible by using a script language like JavaScript to mimic the required behavior. Therefore, a good page analyzer should be able to detect password and other fields via additional means as described above.

Page Analyzer 202a presents Sensitive Information Detector 202b with a list of fields and their meaning (context) their content. Sensitive Information Detector compares each field for which user 204 has entered data with a list of sensitive fields as determined by some default settings of monitoring software 202 and by preferences of user 204. Normally, a password field and a credit card number are considered sensitive information. Sensitive Information Detector 202b signals Alert Detector 202c that sensitive information is being submitted by user 204.

It should be noted, that user 204 behavior can also be implemented by an automatic program. In a preferred embodiment of this invention, a form filling program represents user 204 and fills forms automatically for that user.

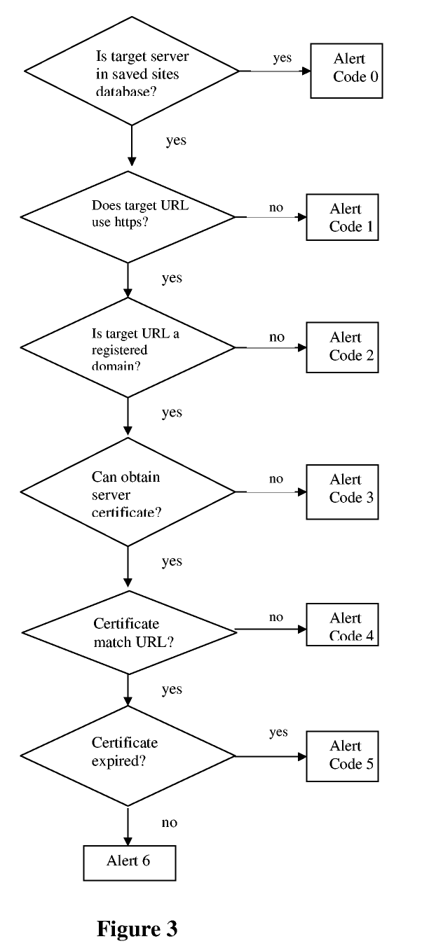

When Alert Detector 202c receives notification 201e that the current web form is about to be submitted and the Sensitive Information message 202b1 is received, it executes the logic described in FIG. 3. Said logic returns an alert code. Alert Detector then compares the alert code with a list of alert conditions determined by user 204. If said alert code matches any of the alerts specified by User 204, User 204 is presented with alert output which manifests itself by visual or other physical means via Output means 204a.

When alert code 0 is set, User 204 is not notified as this code means that said target server has already been checked before and was approved.

When an alert code 1 is set, User 204 is notified that a non-secure web site is the target of the form submission. This notification may be expanded to include further details about the target URL. Such information is readily obtainable from “whois” servers on the internet. Whois servers hold a database of all registered domains. They can be accessed using a protocol defined by standards like RFC 3912. When a site uses non secure access for submitting sensitive personal information, users should be careful and check the site's credential carefully. However, it does not necessarily mean that a site is fraudulent.

When an alert code 2 is set, User 204 is notified that a non-secure non registered domain is the target of the form submission. Users should avoid sending any sensitive information to such sites.

When an alert code 3 is set, User 204 is notified that a secure connection with the target server cannot be established in spite the use of https protocol in the site's address. This case should not cause a problem as the form will not be submitted anyway.

When an alert code 4 is set, User 204 is notified that a site with no certificate or a spoofed certificate is the target of the form submission. Most browsers do protect users from certificates which are not valid so this alert can be informational only.

When an alert code 5 is set, User 204 is notified that a site with an expired secure certificate is the target of the form submission. The details of the certificate are presented to User 204.

When an alert code 6 is set, User 204 is notified that a site with a legitimate certificate is the target of the form submission. The details of the certificate are presented to User 204. Having a valid certificate by itself does not assure a non spoofed site though it is rare. However, by displaying name of the certificate owner, users can easily judge as to the legitimacy of the site.

FIG. 3 is a flowchart describing alert code generation.

If User 204 has already approved a target server in the past, it may not be necessary to check that server again and potential bother User 204 with unnecessary alerts. This is where Saved Sites Database 202f comes into play.

When a user signs-in or submits information to a web site for the first time, the sign-in credentials used for signing-in, together with the URL of the target server, are collected by page analyzer 202a, transferred to Sensitive Information Detector 202b and Alert Detector 202c. Alert Detector 202c saves said information to Saved Sites Database (202f) upon receipt and acknowledgement of submission event from Events Generator 201b.

When Alert Detector 202c later receives a “before navigate” event from events generator 201, it compares the target URL with what is already stored in Database 202f. If a match is found, alert code 0 is set.

Otherwise, if the protocol part of the target URL received from event generator 201b is not secure (http), an alert code 1 is set. If the address part of the target URL is based on an IP address and not on a registered domain, an alert code 2 is set.

Otherwise, Certificate processor 202d requests a digital certificate from the server servicing the target URL (Target Server) 203. Certificate processor, contacts the target server to initiate a SSL or TLS protocol (using standard protocol like RFC 2246 for example).

If Certificate Processor 202d cannot connect with Target Server 203, then alert code 3 is set. If Target Server 203 returns no certificate or the certificate contents do not match the URL of the Target Server (the common name part does not match the server URL), or the certificate is found to be revoked, or the certificate authority which issued the certificate is not valid, an alert code 4 is set. If said digital certificate has expired, or not yet valid, an alert code 5 is set. Otherwise, if a valid certificate is returned, alert code 6 is set.

When user 204 receives an alert, he or she can either enable or disable the submission of form data to Target Server 203. Alert Detector 202c may signal browser 201 that submission of current page should be continued or aborted. In Internet Explorer, this behavior can be implemented by returning a flag to Browser 201 when processing of the “before navigate” event is completed by Alert Detector 202c.

Yet, in an alternate implementation of the current invention targeted at corporate users, a determination to disable form submission can be automated and based on corporate policy. A policy constitutes a set of rules where each rule specifies which alert code should cause the system to block submission of form data to target server 203. Under this scenario, User 204 may still be presented with an alert but it is for informational purpose only.

FIG. 4 describes a system similar to the system described in FIG. 2 but is tuned to process non-HTML forms. The usage of non HTML forms is not common, but is possible, specifically for signing-in to Web sites. In this scenario, User 404 is prompted to provide sign-in credentials by browser 401 itself when the browser accesses a web page that requires authentication in the HTTP protocol used to communicate with that site. This login dialog window also known as Network Login Dialog cannot be analyzed by techniques described in the setup of FIG. 2.

In FIG. 4, Login Detector 402a monitors windows owned by the browser 401 looking for a sign-in window (dialog). Such a window is characterized by a password field. A password field can be detected by a unique attribute assigned to it by the operating system.

Once a login window 401a is detected by Login Detector 402a, it sets a flag for Alert Detector 402c. Alert Detector 402c accesses Browser 401 to retrieve URL 401c of the current site accessed by Browser 401.

Alert Detector 402 then follows the same procedure as described above for FIGS. 2 and 3 to determine if form submission should be blocked.

After receiving a response from User 404 or from an automated policy program, as to whether to submit the login to the target server or decline it, Alert Detector 402c sends a message to window 401a canceling or submitting it per User 404 decision.

What is claimed is:

1. A method for blocking submission of online forms presented by a browsing program comprising the steps of:
detecting form data before a form is submitted to a target site;
accessing said form data;
detecting sensitive form fields within said form data;
analyzing URL and certificate of said target site against security criteria to generate an alert code;
matching said alert code with blocking criteria to generate a match condition;
blocking submission of said form to said target site if said match condition is generated.

2. The method of claim one wherein the step of detecting sensitive form data further includes:
receiving a notification message from said browsing program that form data is about to be submitted;
receiving a URL of said target site together with said notification message.

3. The method of claim two wherein the step of analyzing said target site further includes checking for at least one of the following attributes:
site server being listed in saved sites database;
secure communication protocol in the URL of target site and a valid site server certificate.

4. The method of claim three wherein blocking criteria are determined by a user and the steps of matching alert codes with blocking criteria further include:
inputting by said user a list of alert codes which should cause an alert;
generating a physical alert if any of analysis results match at least one entry in said list;
presenting to said user said physical alert;
accepting enable/disable submission input from said user;
generating a match condition if a disable input is received from said user.

5. The method of claim three wherein preset security triggers are determined by an automated policy and the steps of matching analysis results with blocking criteria further include:
comparing generated alert code with rules specified in an a policy;
generating a match condition if at least one policy rule matches said alert code.

6. The method of claim one wherein the step of detecting form data further includes:
detecting a network login dialog window containing at least a password field;
retrieving a URL of said target site from a browsing program.

7. The methods of claims six wherein the step of analyzing said target site further includes checking for at least one of the following attributes:
site server being listed in saved sites database;
secure communication protocol in the URL of target site and a valid site server certificate.

8. The method of claim seven wherein blocking criteria are determined by a user and the steps of matching alert codes with blocking criteria further include:
inputting by said user a list of alert codes which should cause an alert;
generating a physical alert if any of analysis results match at least one entry in said list;
presenting to said user said physical alert;
accepting enable/disable submission input from said user;
generating a match condition if a disable input is received from said user.

9. The method of claim seven wherein preset security triggers are determined by an automated policy and the steps of matching analysis results with blocking criteria further include:
comparing generated alert code with rules specified in an a policy;
generating a match condition if at least one policy rule matches said alert code.

10. A system for blocking submission of online forms, comprising a computing device with access to a network, a first browsing program adapted to be executed on said device and a second monitoring program adapted to be executed on said device configured to:
accept notifications from said browsing program before a form is submitted to a target site;
access form data in said browsing program and detect form fields of a sensitive nature;
retrieve from said browsing program a URL of said target site;
analyze URL and certificate of said target site against security criteria to generate an alert code;
match said alert code with blocking criteria to generate a match condition;
block submission of said online form to said target site if said match condition is generated.

11. The system of claim ten wherein analyzing URL and certificate constitutes checking for at least one of the following attributes:
site server being listed in saved sites database;
secure communication protocol in the URL of target site and a valid site server certificate.

12. The system of claim eleven where said monitoring program is part of a password management program adapted to be executed on said device.

13. The system of claim eleven wherein said monitoring program is an integrated part of said browsing program.
